(19) United States
(12) Patent Application Publication
(10) Pub. No.: US 2006/0026538 A1
(43) Pub. Date: Feb. 2, 2006

(54) Relational database storage and retrieval of circuit element classifications

(76) Inventors: Gauray Rameshbhai Shah, Caldwell, ID (US); Denise Susan Man, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/089,560

(22) Filed: Jul. 27, 2004

(51) Int. Cl. G06F 17/50

(52) U.S. Cl. 716/1

(57) ABSTRACT

Various embodiments of a system, method and database for storing circuit element classification information in a relational database are disclosed. One database embodiment comprises a block relation, a structure relation, a FET relation, a NET relation and an association relation.

### BACKGROUND

Digital circuits are generally designed and created using software tools. The resulting circuit design is usually stored in a circuit design database which includes information regarding each component of the circuit, including its characteristics and connectivity. For instance, many typical circuit designs use a plurality of field-effect transistors (“FET's”) and their connectivity (“NET's”) to define functional circuits. One or more FET's and possibly one or more NET's may be combined to form a structure, such as, e.g., a mux, a passgate, a clock generator, etc., within the circuit. One or more structures (along with one or more FET's and/or NET's) may be combined in a block of the circuit. Generally speaking, a block is a functional piece of the circuit; i.e., it is a part of the circuit which performs a function. A block may be defined by a broad function and include multiple sub-blocks, structures, FET's and NET's, or it may be more narrowly defined by a specific function and include only structures, FET's and NET's or even just FET's.

Circuit design databases may be accessed for analysis. For example, a circuit recognition analysis takes as an input a circuit in the form of a netlist (as stored in the circuit design database), analyzes it, and outputs a logical circuit classification of each of its elements (including, e.g., blocks, structures, FET's and NET's). Such a process is usually performed by a circuit recognition engine (a “CRE”). The classification information is generally used and/or stored for later use in a single data file—typically a flat file.

As circuits get bigger and more complex, the size and complexity of the classification data file correspondingly increases. For example, many circuit designs involve hundreds of thousands or even millions of elements, and many of these elements have shared and/or inter-related characteristics. Addressing data storage and retrieval needs for circuit classification information has become increasingly challenging.

### SUMMARY

In accordance with one embodiment of the present invention, a database for logical circuit classifications of a digital circuit is provided. The database includes a block relation, a structure relation, a FET relation, a NET relation and an association relation.

In accordance with another embodiment of the present invention, a database for storage of a plurality of logical circuit classifications of a digital circuit is provided. The database includes a block relation having a block record for each block in the circuit, a structure relation having a structure record for each structure in the circuit, a FET property relation having a FET record for each FET in the circuit, a NET property relation having a NET record for each NET in the circuit, and an association relation having a record for each association between a structure and a block in the circuit, between a FET and a structure in the circuit and between a NET and a structure in the circuit.

In accordance with another embodiment of the present invention, a computer-readable medium containing a data structure for use in storing element classifications of a digital circuit is provided. The computer-readable medium includes a plurality of element tables having a record for each element of the circuit and an association table having an association record for each association between elements of the circuit.

In accordance with another embodiment of the present invention, a computer readable medium containing a data structure for use in storing element classifications of a digital circuit is provided. The computer-readable medium includes a block table, a structure table, a FET table, a NET table and an association table.

In accordance with another embodiment of the present invention, a system for storing circuit element classification information in a relational database is provided. The system includes a circuit element classification relational database and relational database storage logic.

In accordance with another embodiment of the present invention, a system for storing circuit element classification information of a digital circuit in a relational database is provided. The system includes a circuit recognition engine, a circuit element classification relational database and relational database storage logic.

In accordance with another embodiment of the present invention, a method for storing circuit element classification information of a digital circuit in relational database is provided. The method includes the steps of receiving classification information regarding an element, creating an element in an element table to represent the element, and creating at least one association record in an association table.

In accordance with another embodiment of the present invention, a method for storing circuit element classification information of a digital circuit in a relational database is provided. The method includes the steps of receiving classification information regarding an element, for each block generating a block identifier and a block record, for each structure generating a structure identifier and a structure record, for each FET generating a FET identifier and FET record, and for each NET generating a NET identifier and a NET record.

### BRIEF DESCRIPTION OF THE DRAWINGS

FIG. 1 is an exemplary overall system diagram of a relational database system for storing and retrieving circuit element classifications in accordance with an embodiment.

FIG. 2 is an exemplary table layout of a relational database structure for storing and retrieving circuit element classifications in accordance with an embodiment.

FIG. 3 is an exemplary system diagram of a component of a system for storing circuit element classifications with a relational database in accordance with an embodiment.

FIG. 4 is a block diagram showing an exemplary methodology for storing circuit element classifications in a relational database in accordance with an embodiment.

FIG. 5 is a block diagram showing an exemplary methodology for adding a record to an element relation in accordance with an embodiment.

FIG. 6 is a block diagram showing an exemplary methodology for adding a record to an association relation in accordance with an embodiment.

### DETAILED DESCRIPTION

The following includes definitions of exemplary terms used throughout the disclosure. Both singular and plural forms of all terms fall within each meaning. Except where noted otherwise, capitalized and non-capitalized forms of all terms fall within each meaning:

As used herein, “relational database” is used generically and includes but is not limited to a collection of data organized as a set of formally-described tables from which the data can be accessed in many different ways without having to reorganize the set of tables.

As used herein, “table” is used interchangeably with “relation.” Both terms are used generically and include but are not limited to data structures used to organize information. A “table” or a “relation” may organize related information into a plurality of records.

As used herein, “element,” as such relates to a circuit design, is used generically and includes but is not limited to a component of a circuit, such as a block, a structure, a FET and a NET.

As used herein, “block,” as such relates to a circuit design, is used generically and includes a logical part of the circuit, such as, e.g., floating point calculations, branching or threading. A “block” may be a collection of other blocks, structure(s), FET('s), NET('s) or combinations thereof.

As used herein, “structure,” as such relates to a circuit design, is used generically and includes a combination of one or more FET('s), NET('s) and other structures, such as, e.g., a clock generator, a catcher, ram, a mux or a passgate.

As used herein, “logic” is used generically and includes but is not limited to hardware, software and/or combinations of both to perform a function.

As used herein, “software” is used generically and includes but is not limited to one or more computer executable instructions, scripts, routines, algorithms, modules or programs (including separate applications or from dynamically linked libraries) for performing functions as described herein. Software may also be implemented in various forms such as a servlet, applet, stand-alone, plug-in or other type of application. Software can be maintained on various computer readable mediums as known in the art.

As used herein, “computer-readable medium” is any medium that contains computer readable information. “Computer-readable medium,” for example, includes electronic, magnetic, optical electromagnetic, infrared, or semiconductor media. More specific examples include but are not limited to a portable magnetic computer diskette such as floppy diskettes or hard drives, a random access memory (RAM), a read-only memory (ROM), an erasable programmable read-only memory, or a portable compact disk.

As used herein, “FET” is used generically and includes any field-effect transistor and any switching component of a circuit.

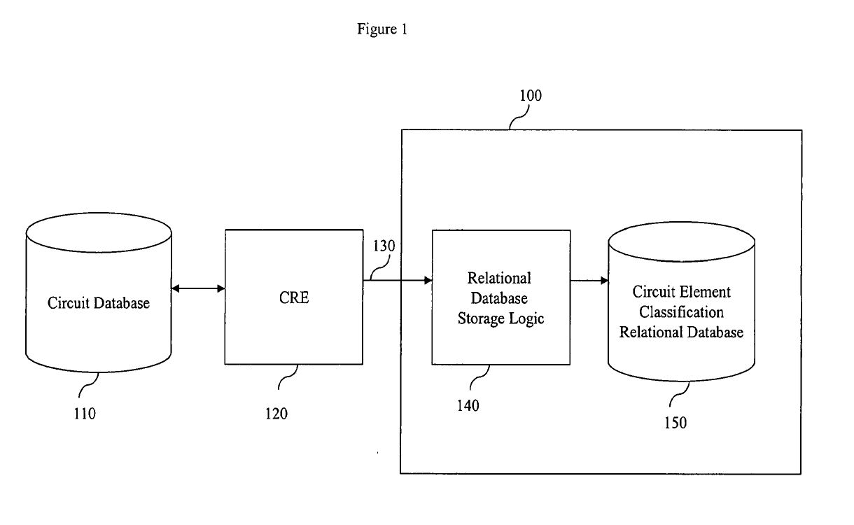

With reference to FIG. 1, an overview of a system for storing and retrieving circuit element classifications with a relational database 100 is shown. A circuit database 110 contains design information regarding a digital circuit, including one or more netlists, a plurality of circuit components, etc. Circuit database 110 is any suitable database (or collection of databases) storing any suitable circuit design information in a format accessible by circuit recognition engine 120.

CRE 120 accesses database 110 and divides the circuit therein into a plurality of elements, including one or more blocks, structures, FET's and/or NET's. CRE 120 classifies each element according to a classification scheme. Any suitable classification scheme is used. For example, each structure is classified as one of a group of structures set forth in Tables 2, 4 and 6, below. Any suitable CRE is used, including but not limited to “Dynamodel” from Circuit Semantics, Inc.

The results of the CRE's 120 analysis of the circuit information in database 110 (e.g., the classification of each identified element in the circuit) are forwarded 130 to system 100 for storage therein and subsequent retrieval therefrom. System 100 receives the circuit element classification information and stores same for subsequent retrieval. In this embodiment, system 100 includes relational database storage logic 140 and circuit element classification relational database 150. Relational database storage logic 140, described below, facilitates storage of the circuit element classification information in circuit element classification relational database 150.

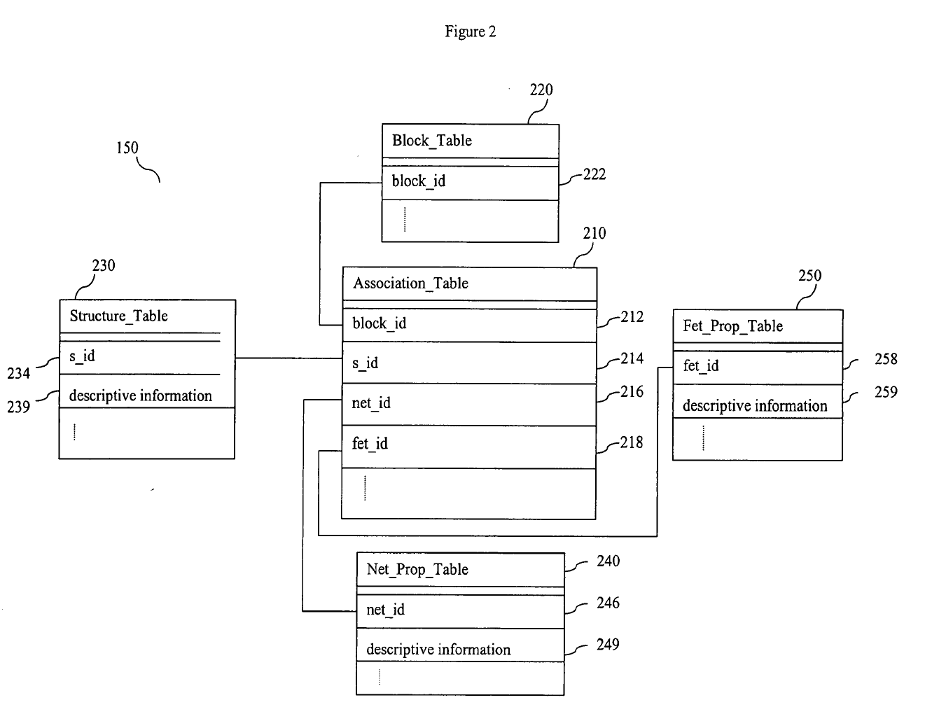

With reference to FIG. 2, in an embodiment, classification database 150 is a relational database including an association table 210, a block table 220, a structure table 230, a NET properties table 240 and a FET properties table 250. While a database 150 of this embodiment is described herein with reference to four circuit elements (blocks, structures, FET's and NET's), it will be appreciated that such a database 150 is extendable for storing and retrieving other elements of a circuit design, such as, e.g., pins, resisters and capacitors. In such embodiments, an additional table is added for each element (e.g., a pin table) and suitable fields and records arc added to the association table (as described below). This description, however, will be limited to the elements: blocks, structures, FET's and NET's.

Block table 220 (also referred to as Block_Table or block_table) is a relation which is formatted to contain information relating to the blocks of the circuit. Generally speaking, each block in the circuit is represented by a record in the block table 220. Each record in the block table (each, a “block record”) contains at least a block identification field 222 (“block_id field”) and optionally additional fields (as described below). The block identification field 222 is formatted to contain an identification of a block (a “block_id”). Any suitable format or data structure is used, including but not limited to an unsigned integer of 10 bytes. Each block represented in a block record has a unique block_id stored in the block identification field 222. The block identification field 222 is optionally a key field of block table 220. As such, block table 220 may be indexed (and efficiently searched) via the block identification field 222.

Structure table 230 (also referred to as Structure_Table or structure_table) is a relation which is formatted to contain information relating to the structures of the circuit. Generally speaking, each structure in the circuit is represented by a record in the structure table 230. Each record in the structure table (each, a “structure record”) contains at least a structure identification field 234 (“s_id field”), one or more fields containing structure descriptive information 239 and optionally additional fields (as described below). The structure identification field 234 is formatted to contain an identification of a structure (an “s_id”). Any suitable format or data structure is used, including but not limited to an unsigned integer of 10 bytes. Each structure represented in a structure record has a unique s_id stored in the structure identification field 234. The structure identification field 234 is optionally a key field of structure table 230. As such, structure table 230 may be indexed (and efficiently searched) via the structure identification field 234. Structure descriptive information field 239 is formatted to contain descriptive information regarding the structure which is the subject of the structure record. Any suitable descriptive information, and any suitable combination of field(s) 239 for storing such information, is used. For example, structure descriptive information field 239 may be a character string of any suitable length (e.g., 255 characters) and may contain a written description of the classification of the structure. Alternatively, structure descriptive information field 239 comprises multiple identification fields, as described below.

Net properties table 240 (also referred to as Net_Prop_Table or net_prop_table) is a relation which is formatted to contain information relating to the NET's of the circuit. Generally speaking, each NET in the circuit is represented by a record in the NET table 240. Each record in the NET table (each, a “NET record”) contains at least a NET identification field 246 (“net_id field”), one or more fields containing NET descriptive information 249 and optionally additional fields (as described below). The NET identification field 246 is formatted to contain an identification of a NET (a “net_id”). Any suitable format or data structure is used, including but not limited to an unsigned integer of 10 bytes. Each NET represented in a NET record has a unique net_id stored in the NET identification field 246. The NET identification field 246 is optionally a key field of NET table 240. As such, NET table 240 may be indexed (and efficiently searched) via the NET identification field 246. NET descriptive information field 249 is formatted to contain descriptive information regarding the NET which is the subject of the NET record. Any suitable descriptive information, and any suitable combination of field(s) 249 for storing such information, is used. For example, NET descriptive information field 249 may comprise multiple fields including the name of the net, the net drivers, etc. and may further contain a written description of the classification of the NET. Alternatively, NET descriptive information field 249 comprises multiple identification fields, as described below.

Fet properties table 250 (also referred to as Fet_Prop_Table or fet_prop_table) is a relation which is formatted to contain information relating to the FET's of the circuit. Generally speaking, each FET in the circuit is represented by a record in the FET table 250. Each record in the FET table (each, a “FET record”) contains at least a FET identification field 258 (“fet_id field”), one or more fields containing FET descriptive information 259 and optionally additional fields (as described below). The FET identification field 258 is formatted to contain an identification of a FET (a “fet_id”). Any suitable format or data structure is used, including but not limited to an unsigned integer of 10 bytes. Each FET represented in a FET record has a unique fet_id stored in the FET identification field 258. The FET identification field 258 is optionally a key field of FET table 250. As such, FET table 250 may be indexed (and efficiently searched) via the FET identification field 258. FET descriptive information field 259 is formatted to contain descriptive information regarding the FET which is the subject of the FET record. Any suitable descriptive information, and any suitable combination of field(s) 259 for storing such information, is used. For example, FET descriptive information field 259 may comprise multiple fields including the name of the FET, the FET width and length, etc. and may further contain a written description of the classification of the FET. Alternatively, FET descriptive information field 259 comprises multiple identification fields, as described below.

Association table 210 (also referred to as Association_Table or association_table) is a relation which is formatted to contain information relating to associations between the blocks, structures, NET's and FET's of the circuit. Generally speaking, each association between a block and a structure, between a structure and a NET, and between a structure and a FET is represented by a record in the Association table 210. Additional associations, such as between a structure and it's parent, as described below, are optionally also represented by a record in the Association table 210.

Each record in the Association Table (each, an “association record”) contains at least a block_id field 212, an s_id field 214, a net_id field 216 and a fet_id field 218. Block_id field 212 is formatted to contain a block_id, s_id field 214 is formatted to contain an s_id, net_id field 216 is formatted to contain a net_id, and fet_id field 218 is formatted to contain a fet_id. Depending upon the association which is the subject of an association record, each of these fields contains either a null or the value of the id of an associated element. For example, each structure in the circuit will have at least one association record representing the association between the structure and the block in which the structure is contained. In this example, the block_id field will contain the block_id of the block which contains the structure, and the s_id field will contain the s_id of the structure which is so contained. The net_id and fet_id fields are optionally null. Similarly, each NET and FET will have at least one association record representing the association between the NET or FET and the structure and/or block which contains the NET or the FET. In such a case, the net_id field or the fet_id field (depending upon whether a NET or a FET is the subject of the association) contains the net_id or the fet_id of the NET or FET contained in the structure or the block. If contained in a structure, the s_id field will contain the s_id of that structure. If not contained in a structure, the s_id field is optionally null. The association record also contains the block_id of the block which contains the NET or the FET.

It will be appreciated that each element may have an identifier contained in multiple associations records. For example, a structure may contain multiple FET's and NET's. An association record will be created for each association between the structure and each FET and NET. It will be further appreciated that when a field is not needed to represent the association, that such field may be left as null (e.g., the net_id field for a FET association). In embodiment, every association between elements of the circuit are represented in at least one association record.

The block_id field 212 is optionally a key field for association table 210. In this regard an index of the block_id values of the association table may be created, facilitating efficient search of the association table 210 by block_id. Similarly, the s_id field 214 is additionally or alternatively a key field for association table 210. As with the block_id field, making the s_id field a key facilitates indexing by the s_id and efficient searching of the association table by structure.

An exemplary embodiment of a block table is set forth below in Table 1. Table 1 represents an exemplary schema for a block table. Table 1 (and the rest of the Tables set forth herein) sets forth exemplary fields for each record of the table in the left-most column. Proceeding left to right, the next column sets forth an exemplary format (or “type”) for each of the fields. While any suitable formats may be used, the following exemplary formats are illustrated: int(10) unsigned (an unsigned integer 10 bytes in length); varchar (255) (a string of characters of variable length, with a maximum length of 255 characters); float (a floating point number); and tinyint(1) (a boolean field). The next column identifies whether, in the illustrated example, the field is a key. A “yes” indicates that the field is a key of the table, and may be a foreign key (particularly if identified as such). “PRI” indicates that the key is the primary key of the table. “MUL” indicates that the field is part of a multiple-column key for the table. A blank, or no indication, indicates that the field is not a key for the table. The next column sets forth exemplary restrictions on the content of the field, and particularly identifies whether the field can be a null. The final column indicates an exemplary default value for each field.

TABLE 1
block_table

| Field | Type | Key | Null | Default |
|---|---|---|---|---|
| block_id | int (10) unsigned | PRI | | |
| block_name | varchar (255) | MUL | | |
| block_path | varchar (255) | MUL | | |

In the embodiment of a block_table set forth in Table 1, it will be appreciated that, in addition to a block_id field (which is optionally a primary key to the block_table), the block_table optionally includes a block_name field and a block_path field. Each of these fields, or the combination of these fields, optionally comprises descriptive information regarding the physical location of the block in the circuit design database which contains the circuit design (i.e., the netlist). The netlist is usually a physical file which is located physically on a storage medium, such as a fixed disk. Each element of the netlist has a location on the storage medium (e.g., usually in a path/directory). The field block_path optionally contains this physical storage location (e.g., the path/directory in which the block is located). The block_name contains the name of the block as set forth in the file saving structure of the storage medium. As multiple blocks in varying locations may share the same name, a combination of the name of the block and the path of the block (the “MUL” key) is necessary to identify each block.

In this regard the block_table is searchable either by block_id (the primary key) or by the combination of a block name and a block location. As set forth below, a unique block_id for each block is created by any suitable method, including by an automatic increment for each block inputted into system 100 for storage (i.e., a block_id of 0000000001 for the first block, 000000002 for the second block, etc.).

An exemplary embodiment of a structure_table is set forth below in Table 2:

TABLE 2
structure_table

| Field | Type | Key | Null | Default |
|---|---|---|---|---|
| s_id | int (10) unsigned | PRI | | NULL |
| is_clock_generator | tinyint (1) | | YES | NULL |
| is_clock_gater | tinyint (1) | | YES | NULL |
| is_catcher | tinyint (1) | | YES | NULL |
| is_latch | tinyint (1) | | YES | NULL |
| is_pulse_latch | tinyint (1) | | YES | NULL |
| is_mux_latch | tinyint (1) | | YES | NULL |
| is_dlc | tinyint (1) | | YES | NULL |
| is_elatch | tinyint (1) | | YES | NULL |
| is_dynamic_footed | tinyint (1) | | YES | NULL |
| is_dynamic_footless | tinyint (1) | | YES | NULL |
| no_keeper | tinyint (1) | | YES | NULL |
| half_keeper | tinyint (1) | | YES | NULL |
| full_keeper | tinyint (1) | | YES | NULL |
| is_ram | tinyint (1) | | YES | NULL |
| is_pseudo_nmos | tinyint (1) | | YES | NULL |
| is_pseudo_dynamic | tinyint (1) | | YES | NULL |
| is_static_cmos | tinyint (1) | | YES | NULL |
| is_static | tinyint (1) | | YES | NULL |
| is_nand | tinyint (1) | | YES | NULL |
| Is_nor | tinyint (1) | | YES | NULL |
| is_inv | tinyint (1) | | YES | NULL |
| is_single_fet | tinyint (1) | | YES | NULL |
| is_non_static | tinyint (1) | | YES | NULL |
| is_tristate | tinyint (1) | | YES | NULL |
| is_combinational | tinyint (1) | | YES | NULL |
| is_forward_driver | tinyint (1) | | YES | NULL |
| is_feedback_driver | tinyint (1) | | YES | NULL |
| is_internal_driver | tinyint (1) | | YES | NULL |
| is_mux | tinyint (1) | | YES | NULL |
| is_passgate | tinyint (1) | | YES | NULL |
| is_passfet | tinyint (1) | | YES | NULL |
| is_happy_gate | tinyint (1) | | YES | NULL |
| is_non_toggling_high | tinyint (1) | | YES | NULL |
| is_non_toggling_low | tinyint (1) | | YES | NULL |
| is_analog | tinyint (1) | | YES | NULL |
| is_deracer | tinyint (1) | | YES | NULL |
| is_annihilation_gate | tinyint (1) | | YES | NULL |
| is_hysterisis | tinyint (1) | | YES | NULL |
| is_self_timed | tinyint (1) | | YES | NULL |
| is_cvsl | tinyint (1) | | YES | NULL |
| has_mult_dyn_structures | tinyint (1) | | YES | NULL |
| has_mult_latch_structures | tinyint (1) | | YES | NULL |
| has_loose_nets_fets | tinyint (1) | | YES | NULL |
| has_extra_properties | tinyint (1) | | YES | NULL |
| fk_block_id | int (10) unsigned | YES | | 0 |

In the embodiment of a structure_table set forth in Table 2, it will be appreciated that, in addition to an s_id field (which is optionally a primary key to the structure_table), the structure_table optionally includes an fk_block_id field (described below), a has_extra_properties field (described below) and a plurality of fields relating to descriptive information regarding the structure, including classification information of the structure.

It will be appreciated that any suitable description information regarding structure classification, including any suitable field(s) structure and/or format, is used to provide descriptive information regarding the structure which is the subject of the structure record. In an embodiment, such descriptive information is contained in a plurality of boolean fields (e.g., in Table 2 in order from is_clock_generator to is_cvsl) and, optionally, additional relation structure_new_classification_table. In this embodiment, a distinction is drawn between frequently-used structure classifications (identified by the list in Table 2) and infrequently-used structure classifications (as described in relation structure_new_classification_table). This classification construct is set forth in the following patent application incorporated herein by reference: “Circuit Design Property Storage and Manipulation,” Ser. No. 60/569029, filed on May 7, 2004.

While a detailed description of this classification construct is beyond the scope of this disclosure, a defined list of frequently-used structure classifications are set forth in the structure_table. In the event that the structure of the structure record is classifiable by any of these defined classifications, the field of the classification contains a “1” (or an “on”) to indicate that the specific classification is identified. The remaining classifications remain null, indicating that they do not apply. The field has_extra_properties also remains null, indicating that a classification was accomplished via one of the boolean fields.

In the event that the enumerated list of classifications can not classify the structure of the structure record, all enumerated classification fields in the structure_table are nulled and the has_extra_properties field is given a “1” (or an “on”) to indicate that the structure_new_classification_table must be accessed to classify the structure. An exemplary schema of a structure_new_classification_table is set forth below in Table 3:

TABLE 3
structure_new_classification_table

| Field | Type | Key | Null | Default |
|---|---|---|---|---|
| s_id | int (10) unsigned | YES | | 0 |
| Classification | varchar (255) | | | |

As indicated in Table 3, structure_new_classification_table includes an s_id field (containing the value of the s_id for the structure of the current structure record) and a classification field. The classification field is formatted to contain a written description of the classification of the structure. Such a written description of the classification of the structure is entered into the classification field.

With reference back to Table 2, the structure_table optionally includes a fk_block_id field. This field is optionally a primary foreign key, and optionally includes the value of the block_id of the block in which the structure of the current structure record is contained. This key is optionally added to the structure_table to facilitate deletion of the structure record from the relational database. For example, if it is determined to delete a block from the database, the structure_table is optionally indexed by the fk_block_id key to facilitate easy search and identification of all structures which were contained in the block. Once such a universe of structures is identified, they may be deleted from the relational database (in order to keep the structure_table in sync with the block_table, which had the block deleted).

The structure_table further optionally includes additional descriptive fields. For example, fields describing the structure, such as has_mult_dyn_structures, has_mult_latch_structures and has_loose_nets_fets fields may be included.

An exemplary embodiment of a fet_prop_table is set forth below in Table 4:

TABLE 4
fet_prop_table

| Field | Type | Key | Null | Default |
|---|---|---|---|---|
| fet_id | int (10) unsigned | PRI | | NULL |
| fet_name | varchar (255) | | | |
| source_net_id | int (10) unsigned | | | 0 |
| drain_net_id | int (10) unsigned | | | 0 |
| gate_net_id | int (10) unsigned | | | 0 |
| fet_width | float | | YES | NULL |
| fet_length | float | | YES | NULL |
| assoc_passfet_id | int (10) unsigned | | YES | NULL |
| is_nmos | tinyint (1) | | YES | NULL |
| is_pmos | tinyint (1) | | YES | NULL |
| is_passfet | tinyint (1) | | YES | NULL |
| is_passgate | tinyint (1) | | YES | NULL |
| is_precharge_fet | tinyint (1) | | YES | NULL |
| is_evaluate_fet | tinyint (1) | | YES | NULL |
| is_interstitial_prchg_fet | tinyint (1) | | YES | NULL |
| is_in_eval_stack | tinyint (1) | | YES | NULL |
| is_scan_passfet | tinyint (1) | | YES | NULL |
| is_scan_passgate | tinyint (1) | | YES | NULL |
| is_catcher_feedback_fet | tinyint (1) | | YES | NULL |
| is_bypass_cap | tinyint (1) | | YES | NULL |
| has_extra_properties | tinyint (1) | | YES | NULL |
| fk_block_id | Int (10) unsigned | YES | | 0 |

As with the structure_table, it will be appreciated that in addition to a fet_id field (which is optionally a primary key to the fet_prop_table), the fet_prop_table optionally includes a fk_block_id field, a has_extra_properties field, and a plurality of descriptive information fields, including boolean classification identifiers (e.g., is_nmos to is_bypass_cap) and other identifiers (including the fields fet_name through assoc_passfet_id). As with the structure_table, the boolean classification identifiers are optionally used to identify a classification in one of the pre-defined fields. If no such classification of the FET exists, the has_extra_properties field is implicated and the classification is set forth in the optional relation fet_new_classification_table, an exemplary embodiment of which is set forth below in Table 5:

TABLE 5
fet_new_classfication_table

| Field | Type | Key | Null | Default |
|---|---|---|---|---|
| fet_id | int (10) unsigned | YES | | 0 |
| property | varchar (255) | | | |
| value | varchar (255) | | | |

As with Table 3, the id field (here, the fet_id) contains the identifier of the FET which is the subject of the FET record, and either or both of the property and value fields are used to describe the classification of the FET.

With reference back to Table 4, fet_prop_table optionally further includes an fk_block_id field, which performs the same function as the same field in the structure_table. Here, the fk_block_id field contains the id of the block which contains the FET of the FET record in order to facilitate deletion of the FET record in the event the block is deleted from the database. The “other” descriptive classification fields (e.g., fet_name, source_net_id, etc.) are optionally included to provide additional descriptive information regarding the FET.

An exemplary embodiment of a net_prop_table is set forth below in Table 6:

TABLE 6
net_prop_table

| Field | Type | Key | Null | Default |
|---|---|---|---|---|
| net_id | int (10) unsigned | PRI | | NULL |
| net_name | varchar (255) | | | |
| driver_n_strength | float | | YES | NULL |
| driver_p_strength | float | | YES | NULL |
| is_scan_clk | tinyint (1) | | YES | NULL |
| is_not_scan_clk | tinyint (1) | | YES | NULL |
| is_phase_clk | tinyint (1) | | YES | NULL |
| is_not_phase_clk | tinyint (1) | | YES | NULL |
| is_rck_clk | tinyint (1) | | YES | NULL |
| is_not_rck_clk | tinyint (1) | | YES | NULL |
| is_pulse_clk | tinyint (1) | | YES | NULL |
| is_not_pulse_clk | tinyint (1) | | YES | NULL |
| is_pwr | tinyint (1) | | YES | NULL |
| is_gnd | tinyint (1) | | YES | NULL |
| is_boundary_port | tinyint (1) | | YES | NULL |
| is_pseudo_boundary_port | tinyint (1) | | YES | NULL |
| is_latch_node | tinyint (1) | | YES | NULL |
| is_ram_node | tinyint (1) | | YES | NULL |
| is_ram_read_enable | tinyint (1) | | YES | NULL |
| is_ram_write_enable | tinyint (1) | | YES | NULL |
| is_dynamic | tinyint (1) | | YES | NULL |
| is_precharge_node | tinyint (1) | | YES | NULL |
| is_precharge_input_net | tinyint (1) | | YES | NULL |
| is_evaluate_input_net | tinyint (1) | | YES | NULL |
| is_evaluate_stack_net | tinyint (1) | | YES | NULL |
| is_interstitial_net | tinyint (1) | | YES | NULL |
| is_interstitial_precharge_net | tinyint (1) | | YES | NULL |
| is_scan_input | tinyint (1) | | YES | NULL |
| is_mux_select | tinyint (1) | | YES | NULL |
| is_mux_data | tinyint (1) | | YES | NULL |
| is_pseudo_nmos | tinyint (1) | | YES | NULL |
| is_non_toggling_hight | tinyint (1) | | YES | NULL |
| is_non_toggling_low | tinyint (1) | | YES | NULL |
| has_extra_properties | tinyint (1) | | YES | NULL |
| Fk_block_id | int (10) unsigned | YES | | 0 |

As with the fet_prop_table, it will be appreciated that in addition to a net_id field (which is optionally a primary key to the net_prop_table), the net_prop_table optionally includes a fk_block_id field, a has_extra_properties field, and a plurality of descriptive information fields, including boolean classification identifiers (e.g., is_scan_clk to is_non_toggling_low) and other identifiers (including the fields net_name through driver_p_strength). As with the fet_prop_table, the boolean classification identifiers are optionally used to identify a classification in one of the pre-defined fields. If no such classification of the NET exists, the has_extra_properties field is implicated and the classification is set forth in the optional relation net_new_classification_table, an exemplary embodiment of which is set forth below in Table 7:

TABLE 7
net_new_classification_table

| Field | Type | Key | Null | Default |
|---|---|---|---|---|
| net_id | int (10) unsigned | YES | | 0 |
| property | varchar (255) | | | |
| value | varchar (255) | | | |

As with Table 5, the id field (here, the net_id) contains the identifier of the NET which is the subject of the NET record, and either or both of the property and value fields are used to describe the classification of the NET.

With reference back to Table 6, net_prop_table optionally further includes an fk_block_id field, which performs the same function as the same field in the structure_table. Here, the fk_block_id field contains the id of the block which contains the NET of the NET record in order to facilitate deletion of the NET record in the event the block is deleted from the database. The “other” descriptive classification fields (e.g., net_name, driver_n_strength, etc.) are optionally included to provide additional descriptive information regarding the NET.

An exemplary embodiment of an association_table is set forth below in Table 8:

TABLE 8
Association_table:

| Field | Type | Key | Null | Default |
|---|---|---|---|---|
| block_id | int (10) unsigned | YES | | 0 |
| parent_s_id | int (10) unsigned | | YES | NULL |
| s_id | int (10) unsigned | YES | | 0 |
| net_id | int (10) unsigned | | YES | NULL |
| fet_id | int (10) unsigned | | YES | NULL |
| is_input | tinyint (1) | | YES | NULL |
| is_inout | tinyint (1) | | YES | NULL |
| is_ouput | tinyint (1) | | YES | NULL |

As set forth above, an association_table includes fields for block_id, s_id, net_id and fet_id, with the block_id field optionally a key for the association table. In an embodiment, the s_id field is additionally or alternatively a key for the association table. In this regard the association_table may be indexed by either or both the block_id and the s_id, and expedited searching by either field is thus achieved.

Association_table further optionally includes a parent_s_id field. This field optionally contains the id of the structure which is the parent to the structure which is the subject of the structure record. For example, for a single structure the association_table will have a record for the association between the structure and the block that contains the structure, and a record for each FET and NET which is included in the structure. In embodiments including a parent_s_id field, at least one additional association record will be added to the association_table. This record will contain information regarding the association between the structure of the structure record and that structure's parent. Such a record contains a value for s_id (the structure of the structure record), the parent_s_id (the id of the parent of that structure) and, optionally, a block_id of the block which contains each structure. In this event none of the other fields need contain a value outside of null.

Association_table further optionally includes a plurality of input/output identifiers, exemplified by the fields is_input, is_inout and is_ouput. Such fields are optionally used to describe the input/output nature of a structure, block, NET or FET (or the association between thereof) which is the subject of the association record.

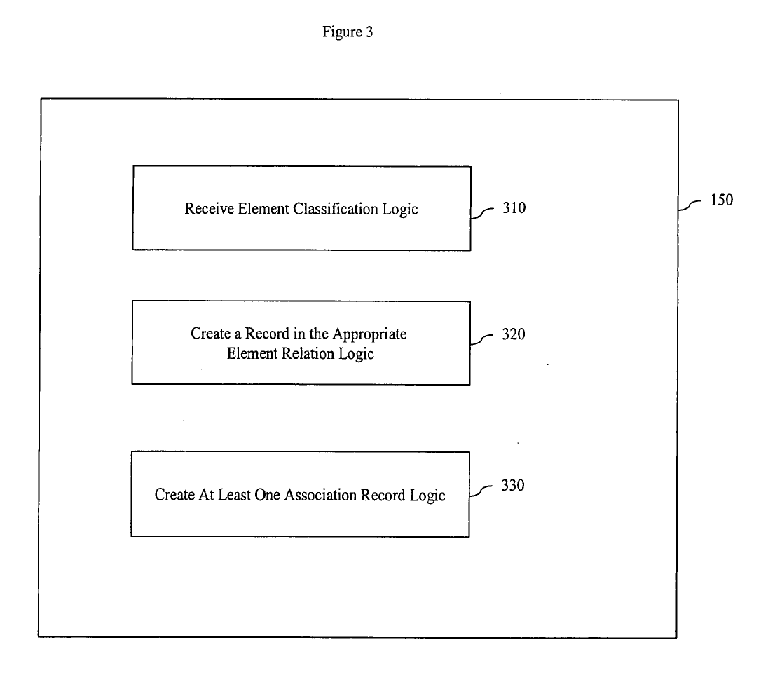

With reference back to FIG. 1, system 100 includes relational database storage logic 150. Relational database storage logic 150 includes any suitable steps, methods, processes and/or software for receiving element classification information and storing same in circuit element classification relational database 140. In an exemplary embodiment, with reference to FIG. 3, relational database storage logic 150 includes receive element classification logic 310, create a record in an appropriate element relation logic 320 and create at least one association record logic 330.

Receive element classification logic 310 includes any suitable steps, methods, processes and/or software for receiving elements and classification information regarding the elements from CRE 120. Such information is received in any suitable way. For example, receive element classification logic 310 may receive classification information regarding an element after CRE 120 identifies the element and classifies it. In this manner system 100 interacts with CRE 120 in real time, receiving CRE 120 classification output as CRE 120 creates same. Alternatively, receive classification logic 310 receives element classification information in a batch process. In this case, results from CRE 120 classification are stored (e.g., in a temporary file) for later batch processing by system 100.

Create a record in an appropriate element relation logic 320 includes any suitable steps, methods, processes and/or software for storing classification information regarding an element in an appropriate element table. As used herein, an “element table” or an “element relation” is one of the four tables including the block table, the structure table, the FET table or the NET table. Upon receiving an element and classification information thereon, create a record in an appropriate element relation logic 320 creates a record in an element table associated with the element and includes the classification information in the record.

For example, if the element is a block, create a record in an appropriate element relation logic 320 creates a block record in the block table. A unique block_id is created and stored in the block_id field of the block record (this unique id is thus associated with that block). Optionally, the block_id is created by an auto-incrementing counter, so that each block record has a unique block_id. Further optionally, descriptive information regarding the block is added to the block record. For example, the name of the block is added to the block_name field and the path/directory of the block is added to the block_path field.

If the element is a structure, create a record in an appropriate element relation logic 320 creates a structure record in the structure table. A unique s_id is created and stored in the s_id field of the structure record. Optionally, the s_id is created by an auto-incrementing counter. Classification information regarding the structure is added to the structure record. For example, if a set of boolean classification values are used, the appropriate boolean field is turned on (unless the set does not contain the appropriate classification, at which point the has_extra_properties boolean is turned on and the structure classification information is added to the structure_new_classification_table). If the structure record has an fk_block_id field, the block_id of the block in which the structure resides is added to the fk_block_id field.

If the element is a FET, create a record in an appropriate element relation logic 320 creates a FET record in the FET table. A unique fet_id is created and stored in the fet_id field of the FET record. Optionally, the fet_id is created by an auto-incrementing counter. Classification information regarding the FET is added to the FET record. For example, if a set of boolean classification values are used, the appropriate boolean field is turned on (unless the set does not contain the appropriate classification, at which point the has_extra_properties boolean is turned on and the FET classification information is added to the fet_new_classification_table). Optionally, FET description information (e.g., the FET name, the FET width and length, etc.) is added to the FET record in the appropriate fields. If the FET record has an fk_block_id field, the block_id of the block in which the FET resides is added to the fk_block_id field.

If the element is a NET, create a record in an appropriate element relation logic 320 creates a NET record in the NET table. A unique net_id is created and stored in the net_id field of the NET record. Optionally, the net_id is created by an auto-incrementing counter. Classification information regarding the NET is added to the NET record. For example, if a set of boolean classification values are used, the appropriate boolean field is turned on (unless the set does not contain the appropriate classification, at which point the has_extra_properties boolean is turned on and the NET classification information is added to the net_new_classification_table). Optionally, NET description information (e.g., the NET name, driver strengths, etc.) is added to the NET record in the appropriate fields. If the NET record has an fk_block_id field, the block_id of the block in which the NET resides is added to the fk_block_id field.

Create at least one association record logic 330 includes any suitable steps, methods, processes and/or software for creating at least one association record in the association table to represent an association between the added element and another element. For example, if the element added to the database 140 is a structure, after adding a structure record to the structure table, create at least one association record logic 330 creates at least one association record regarding the added structure in the association table. The added association record associates the structure to the block that contains it by including the s_id identifier of the structure in the s_id field and the block_id identifier in the block_id field. All other fields in the association record are optionally null. Further optionally, input/output classification information regarding the structure is added to the association record by turning the appropriate input/inout/output boolean field on. In embodiments wherein the association table includes a parent_s_id field, an additional association record is added to the association table for the structure. The additional association record includes the s_id value of the structure in the s_id field, the block_id value in the block_id field, and the s_id value of the parent structure of the added structure (if such a parent structure exists) in the parent_s_id field. In this regard upward hierarchical searching is facilitated, as the parent of a structure (if it exists) is easily determined. All other fields in the association record are optionally null, unless input/inout/output boolean information is added.

If the element added to the database 140 is a FET, after adding a FET record to the FET table, create at least one association record logic 330 creates at least one association record regarding the added FET in the association table. The added association record associates the FET to the structure and block that contains it by including the fet_id of the FET in the fet_id field, the s_id identifier of the structure in the s_id field and the block_id identifier in the block_id field. All other fields in the association record are optionally null, unless input/inout/output boolean information is added.

If the element added to the database 140 is a NET, after adding a NET record to the NET table, create at least one association record logic 330 creates at least one association record regarding the added NET in the association table. The added association record associates the NET to the structure and block that contains it by including the net_id of the NET in the net_id field, the s_id identifier of the structure in the s_id field and the block_id identifier in the block_id field. All other fields in the association record are optionally null, unless input/inout/output boolean information is added.

It will be appreciated that the logic and sub-logics of relational database storage logic 150 are optionally iteratively performed. For example, upon receiving a block and after adding a block record representing the block, relational storage logic 150 will iteratively parse the block for each element therein. Each structure (and the associated classification information) will be received and added into the database 140, including all substructure and all NET's and FET's of the structure(s) and substructure(s).

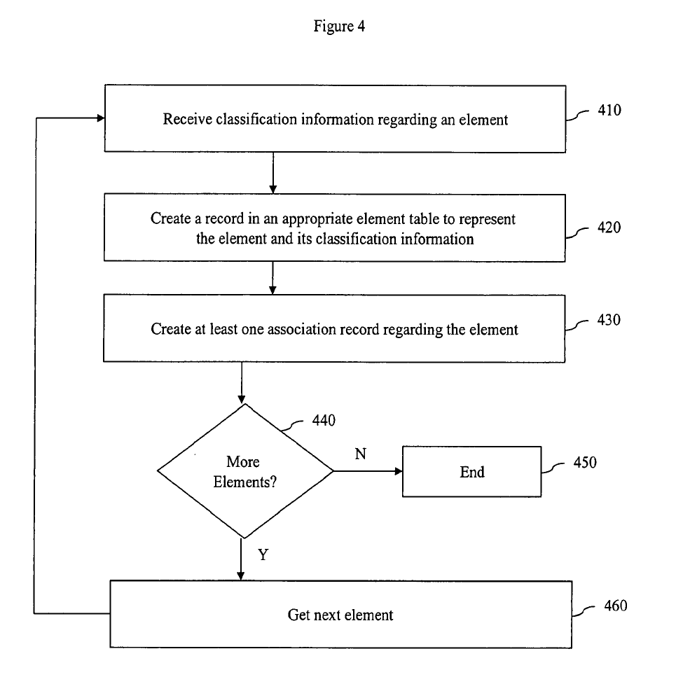

FIGS. 4-6 show an exemplary methodologies for storing circuit element classifications in a relational database. The blocks shown represent functions, actions or events performed therein. If embodied in software, each block may represent a module, segment or portion of code that comprises one or more executable instructions to implement the specified logical function(s). If embodied in hardware, each block may represent one or more circuits or other electronic devices to implement the specified logical function(s). It will be appreciated that computer software applications involve dynamic and flexible processes such that the functions, actions or events performed by the software and/or the hardware can be performed in other sequences different than the one shown.

With reference to FIG. 4, an exemplary methodology is described. At block 410, classification information regarding an element is received. Any suitable classification information is received. For example, the nature of the element (a block, a structure, a FET or a NET) is received. Depending upon the nature of the element, additional classification information is optionally received. For example, if the element is a block, a block name and a block is optionally received. If the element is a structure, a classification of the structure (descriptive information) is also received. If the element is a NET or a FET, a classification and/or other descriptive information is also optionally received. If the element is a structure, FET or NET, information regarding the block (e.g., the block_id) in which the element is contained is received. If the element is a structure, information regarding any parent structure thereof (if such exists) is also received.

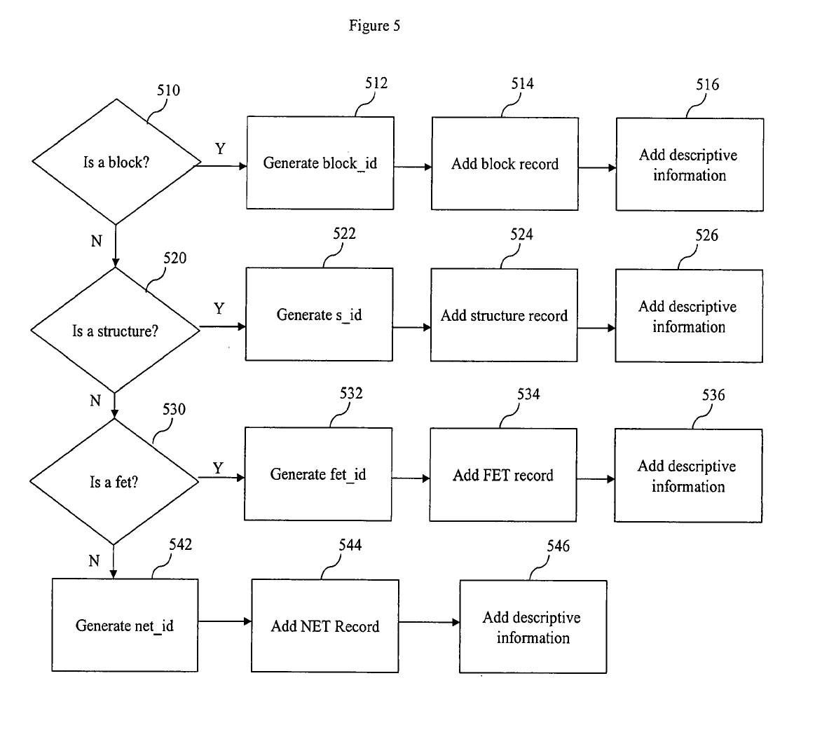

At block 420 a record is created in an appropriate element table to represent the element and its classification information. Any suitable method for creating such a record is used. With reference to FIG. 5, exemplary steps for creating a record in an appropriate element table to represent the element and its classification information are described.

At block 510 it is determined whether the element is a block. If the element is a block, at block 512 a block_id is created by any suitable means (e.g., auto-incremented). At block 514 a block record is created and added to the block table. The block_id is added to the block record. At block 516, additional descriptive information, such as a block name and/or a block path, is optionally added to the block record.

If at block 510 it is determined that the element is not a block, at block 520 it is determined whether the element is a structure. If the element is a structure, at block 522 an s_id is created by any suitable means. At block 524 a structure record is created and added to the structure table. The s_id is added to the structure record. At block 526, additional description information, such as a boolean classifier (or an entry into structure_new_classification_table, as described herein), is added to the structure record. An fk_block_id is also optionally added to the structure record.

If at block 520 it is determined that the element is not a structure, at block 530 it is determined whether the element is a FET. If the element is a FET, at block 532 a fet_id is created by any suitable means. At block 534 a FET record is created and added to the FET table. The fet_id is added to the structure record. At block 536, additional description information, such as a FET name, width, length, etc. and classification information (including boolean classifiers or an entry into fet_new_classification_table), is optionally added to the FET record. An fk_block_id is also optionally added to the FET record.

If at block 530 it is determined that the element is not a FET, at block 542 a net_id is created by any suitable means. At block 544 a NET record is created and added to the NET table. The net_id is added to the NET record. At block 546, additional description information, including a NET name, driver strength, etc. and classification information (including boolean classifiers or an entry into net_new_classification_table), is optionally added to the NET record. An fk_block_id is also optionally added to the NET record.

While the elements in FIG. 5 have been divided in an exemplary order of block, structure, FET and NET, it will be appreciated that an element is stored as a block, structure, FET or NET in any suitable order. For example, it may first be determined whether an element is FET, then whether it is a NET, and then whether it is a structure.

With reference again to FIG. 4, at block 430 at least one association record regarding the element is created and stored in the association table. Any suitable association records are created and stored. With reference to FIG. 5, exemplary steps for creating and storing at least one association record regarding the element in the association table are described.

At block 610, it is determined whether the element is a structure. If the element is a structure, at block 620 an association record is created representing the association between the structure and the block the structure is contained within. This association record is added to the association table. The association record contains the s_id of the structure and the block_id of the block. All other association record fields are optionally null. The structure's status as input/inout/output may be recorded in the association record.

At block 630 it is determined whether the structure has a parent structure. If a parent structure exists, at block 640 an association record is optionally created representing the relationship between the structure and its parent structure. This association record is added to the association table. The association record contains the s_id of the structure and the s_id of the parent structure (contained in the parent_s_id field). The block_id field is optionally filled with the block_id of the block which contains the structure. All other association record fields are optionally null. The structure's status as input/inout/output may be recorded in the association record.

If at 610 it is determined that the element is not a structure, or if at 630 it is determined that the structure does not have a parent, or upon completion of block 640, processing continues at block 650. At block 650 it is determined whether the element is a FET. If the element is a FET, at block 660 an association record is created representing the association between the FET and the structure the FET is contained within. This association record is added to the association table. The association record contains the fet_id of the FET, the s_id of the structure, and optionally the block_id of the block in which the FET resides. All other association record fields are optionally null. The FET's status as input/inout/output may be recorded in the association record.

If at block 650 it is determined that the element is not a FET, or upon completion of block 660, processing continues at block 670. At block 670 it is determined whether the element is a NET. If the element is a NET, at block 680 an association record is created representing the association between the NET and the structure the NET is contained within. This association record is added to the association table. The association record contains the net_id of the NET, the s_id of the structure, and optionally the block_id of the block in which the NET resides. All other association record fields are optionally null. The NET's status as input/inout/output may be recorded in the association record.

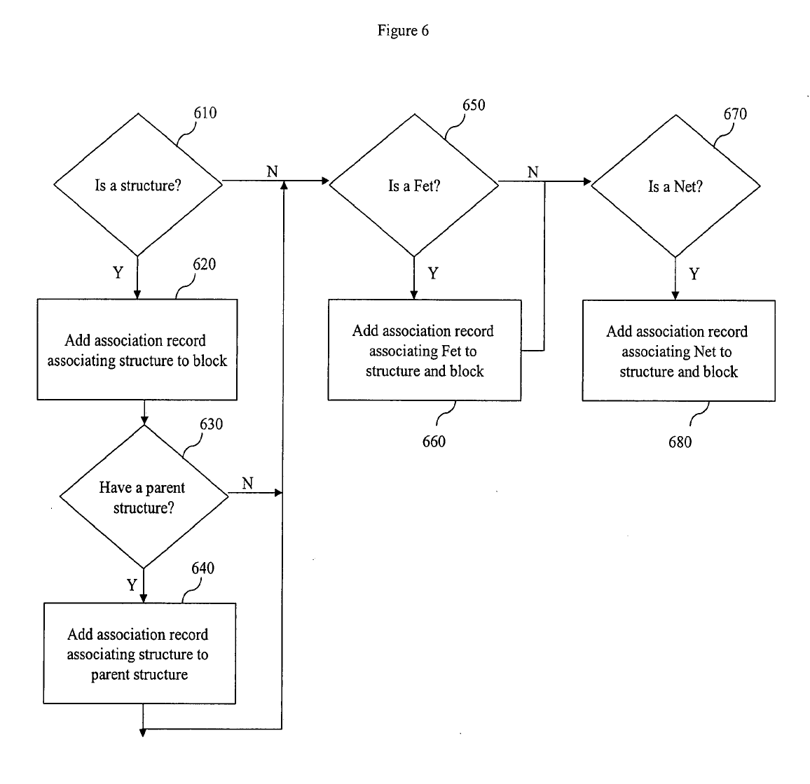

While the exemplary steps of FIG. 6 have been described in the processing order of structure, FET and NET, it will be appreciated that any order of element processing is optionally used. For example, FET's and NET's are optionally determined first, then structures are processed.

With reference again to FIG. 4, at 440 it is determined whether there arc more elements or more element classifications to store in database 150. If no such elements or classifications exist, processing may end at block 450. If additional element(s) exist, at block 460 the next element is received and processing iterates back to block 410.

It will be appreciated that processing of the elements of a circuit is optionally an iterative process. In this light, upon receiving a block, system 100 optionally examines the block to determine what structures, substructures, FET's and NET's are contained therein. The system iteratively parses the block to process each element therein. This iterative process may be similarly applied to all of the blocks of the circuit. Some blocks may have sub-blocks therein. System 100 optionally iteratively parses though the blocks and their sub-blocks, and the structures, sub-structures, NET's and FET's therein.

Although the flow charts herein show exemplary orders of execution, it is understood that the order of execution for other embodiments may differ from that which is depicted. Also, two or more blocks shown herein may be combined and/or executed concurrently or with partial concurrence. It is understood that all such variations are within the scope of various embodiments of the present invention.

While the present invention has been illustrated by the description of embodiments thereof, and while the embodiments have been described in considerable detail, the scope of the appended claims should not be restricted or in any way limited to such detail. Additional advantages and modifications will readily appear to those skilled in the art. Therefore, the invention, in its broader aspects, is not limited to the specific details, the representative systems, and illustrative examples shown and described. Accordingly, departures may be made from such details without departing from the spirit or scope of the invention disclosed herein.

We claim:

1. A database for logical circuit classifications of a digital circuit represented in a circuit design database and having a plurality of blocks, structures, FET's and NET's comprising:
a block relation having a block identifier field as a primary key, the block identifier field formatted to contain a unique identifier for each block represented in the circuit design database;
a structure relation having a structure identifier field as a key, the structure identifier field formatted to contain a unique identifier for each structure represented in the circuit design database;
a FET property relation having a FET identifier field as a key, the FET identifier field formatted to contain a unique identifier for each FET represented in the circuit design database;
a NET property relation having a NET identifier field as a key, the NET identifier field formatted to contain a unique identifier for each NET represented in the circuit design database; and
an association relation having a block identifier field, a structure identifier field, a FET identifier field and a NET identifier field, wherein the block identifier field is a key of the association relation.

2. The database of claim 1 wherein each block of the circuit design is represented by a record in the block relation.

3. The database of claim 2 wherein each block record includes a unique identifier of the block in the block identifier field and descriptive information regarding a physical location of the block in the circuit design database.

4. The database of claim 3 wherein the descriptive information includes a block name field formatted to contain a name of the block and a block path field formatted to contain a path of the block.

5. The database of claim 4 wherein the block name field and the block path field are a multiple-column key for facilitating indexing of the block relation by block name and block path.

6. The database of claim 2 wherein the block identifier field is an unsigned integer and the unique identifier is automatically incremented upon insertion of a new block record.

7. The database of claim 1 wherein each structure of the circuit design is represented by a record in the structure relation.

8. The database of claim 7 wherein each structure record includes a unique identifier of the structure in the structure identifier field and at least one field for descriptive information regarding classification of the structure.

9. The database of claim 8 wherein the descriptive information includes a plurality of boolean fields for identifying the classification of the structure, each boolean field representing a structure classification.

10. The database of claim 9 further comprising:
a structure new classification relation having a structure identifier field as a key and at least one field for descriptive information regarding the properties of the structure, the at least one field formatted to receive descriptive structure classification information, whereby in the event the structure can not be classified by any of the boolean fields of the structure relation, the structure classification is described in the at least one field of the structure new classification relation.

11. The database of claim 7 wherein each structure record includes an fk_block_id field for facilitating deletion of the structure record.

12. The database of claim 7 wherein the structure identifier field is an unsigned integer and the unique identifier is automatically incremented upon insertion of a new structure record.

13. The database of claim 1 wherein each FET of the circuit design is represented by a record in the FET property relation.

14. The database of claim 13 wherein each FET record includes a unique identifier of the FET in the FET identifier field and at least one field for descriptive information regarding the properties of the FET.

15. The database of claim 14 wherein the descriptive information includes a plurality of boolean fields for identifying the FET, each boolean field representing a FET classification.

16. The database of claim 15 further comprising:
a fet new classification relation having a fet identifier field as a key and at least one field for descriptive information regarding the properties of the FET, the at least one field formatted to receive descriptive FET classification information, whereby in the event the FET can not be identified in any of the boolean fields of the FET property relation, the FET is identified in the at least one field of the fet new classification relation.

17. The database of claim 13 wherein each FET record includes an fk_block_id field for facilitating deletion of the FET record.

18. The database of claim 13 wherein the FET identifier field is an unsigned integer and the unique identifier is automatically incremented upon insertion of a new FET record.

19. The database of claim 1 wherein each NET of the circuit design is represented by a record in the NET property relation.

20. The database of claim 19 wherein each NET record includes a unique identifier of the NET in the NET identifier field and at least one field for descriptive information regarding the properties of the NET.

21. The database of claim 20 wherein the descriptive information includes a plurality of boolean fields for identifying the NET, each boolean field representing a NET classification.

22. The database of claim 21 further comprising:
a net new classification relation having a net identifier field as a key and at least one field for descriptive information regarding the properties of the NET, the at least one field formatted to receive descriptive NET classification information, whereby in the event the NET can not be identified in any of the boolean fields of the NET property relation, the NET is identified in the at least one field of the net new classification relation.

23. The database of claim 19 wherein each NET record includes an fk_block_id field for facilitating deletion of the NET record.

24. The database of claim 19 wherein the NET identifier field is an unsigned integer and the unique identifier is automatically incremented upon insertion of a new NET record.

25. The database of claim 1 wherein each structure in the circuit design database is represented by at least one record in the association relation, the association record including the unique identifier of the structure and the unique identifier of the block in which the structure is contained.

26. The database of claim 1 wherein each FET in the circuit design database is represented by at least one record in the association table, the association record including the unique identifier of the FET and the unique identifier of the structure in which the FET is contained.

27. The database of claim 26, the association record further including the unique identifier of the block in which the FET is contained.

28. The database of claim 1 wherein each NET in the circuit design database is represented by at least one record in the association table, the association record including the unique identifier of the NET and the unique identifier of the structure in which the NET is contained.

29. The database of claim 28, the association record further including the unique identifier of the block in which the NET is contained.

30. The database of claim 25, the association relation further including a parent structure identifier field, the parent structure identifier field formatted to contain the unique identifier of a parent structure in which the structure is contained.

31. The database of claim 30 wherein each structure/parent association is represented by at least one record in the association table, the association record including the unique identifier of the structure and the unique identifier of the parent structure.

32. The database of claim 25, the association relation further including input/inout/output descriptive information.

33. A database for storage of a plurality of logical circuit classifications of a digital circuit containing blocks, structures, FET's and NET's comprising:
a block relation, the block relation formatted to have a record for each block of the circuit and including a block identifier field as a primary key formatted to contain a unique identifier for each block in the circuit;
a structure relation, the structure relation formatted to have a record for each structure of the circuit and including a structure identifier field as a primary key formatted to contain a unique identifier for each structure in the circuit, wherein each structure record is formatted to contain descriptive information regarding a classification of a structure;
a FET property relation, the FET property relation formatted to have a record for each FET of the circuit and including a FET identifier field as a primary key formatted to contain a unique identifier for each FET in the circuit, wherein each FET record is formatted to contain descriptive information regarding a classification of a FET;
a NET property relation, the NET property relation formatted to have a record for each NET of the circuit and including a NET identifier field as a primary key formatted to contain a unique identifier for each NET in the circuit, wherein each NET record is formatted to contain descriptive information regarding a classification of a NET; and
an association relation, the association relation formatted to have a record for each association between a structure and a block of the circuit, between a FET and a structure and between a NET and a structure, and wherein the association relation includes a block identifier field, a structure identifier field, a FET identifier field and a NET identifier field.

34. The database of claim 33, the association relation further formatted to have a record for each association between a structure and a parent structure to the structure, and wherein the association relation further includes a parent structure identifier field.

35. The database of claim 34 wherein:
an association record for an association between a structure and a block contains a unique structure identification in the structure identifier field and a unique block identification in the block identifier field;
an association record for an association between a structure and a FET contains a unique structure identification in the structure identifier field and a unique FET identification in the FET identifier field;
an association record for an association between a structure and a NET contains a unique structure identification in the structure identifier field and a unique NET identification in the NET identifier field; and
an association record for an association between a structure and a parent structure contains a unique structure identification in the structure identifier field and a unique structure identification of the parent structure in the parent structure identifier field.

36. A computer-readable medium containing a data structure for use in storing element classifications of a digital circuit, the data structure containing:
a plurality of element tables having a record for each element of the circuit including descriptive information of each element; and
an association table having an association record for each association between elements of the circuit.

37. The computer-readable medium of claim 36, the plurality of element tables comprising a block table, a structure table, a FET table and a NET table, wherein the block table contains a record for each block in the circuit, the structure table contains a record for each structure in the circuit, the FET table contains a record for each FET in the circuit, and the NET table contains a record for each NET in the circuit.

38. The computer-readable medium of claim 36, the association table having an association record for each association between a structure and a block in which the structure is contained, an association record for each association between a FET and a structure in which the FET is contained, and an association record for each association between a NET and a structure in which the NET is contained.

39. The computer-readable medium of claim 38, the association table further having an association record for each association between a structure and a parent structure containing the structure.

40. The computer-readable medium of claim 37, wherein the block table includes a block_id field for containing a unique identifier of each block in the circuit, the structure table includes an s_id for containing a unique identifier of each structure in the circuit, the FET table includes a fet_id for containing a unique identifier of each FET in the circuit, and the NET table includes a net_id for containing a unique identifier of each NET in the circuit.

41. A computer-readable medium containing a data structure for use in storing element classifications of a digital circuit, the data structure containing:
a block table, a structure table, a FET table and a NET table, wherein the block table contains a record for each block in the circuit, the structure table contains a record for eac structure in the circuit, the FET table contains a record for each FET in the circuit, and the NET table contains a record for each NET in the circuit; and
an association table having an association record for each association between a structure and a block in which the structure is contained, an association record for each association between a FET and a structure in which the FET is contained, and an association record for each association between a NET and a structure in which the NET is contained.

42. The computer-readable medium of claim 41, wherein each record in the structure table is formatted to contain classification information regarding a structure, each record in the FET table is formatted to contain classification information regarding a FET, and each record in the NET table is formatted to contain classification information regarding a NET.

43. A system for storing circuit element classification information in a relational database comprising:
a circuit element classification relational database for storing the element classification information; and
a relational database storage logic for receiving the element classification information and storing the information in the circuit element classification relational database.

44. The system of claim 43, the relational database storage logic comprising:
receive element classification logic for receiving element classification information regarding each element in a circuit;
create a record in an appropriate element relation logic for creating a record in a table of the circuit element classification relational database for containing element classification information regarding an element; and
create at least one association record logic for creating at least one association record in an association table of the circuit element classification relational database for each association between elements of the circuit.

45. The system of claim 43, the circuit element classification relation database having:
a block table, a structure table, a FET table and a NET table, wherein the block table contains a record for each block in the circuit, the structure table contains a record for each structure in the circuit, the FET table contains a record for each FET in the circuit, and the NET table contains a record for each NET in the circuit; and
an association table having an association record for each association between a structure and a block in which the structure is contained, an association record for each association between a FET and a structure in which the FET is contained, and an association record for each association between a NET and a structure in which the NET is contained.

46. A system for storing circuit element classification information of a digital circuit in a relational database comprising:
a circuit recognition engine for classifying the elements of the circuit;
a circuit element classification relational database for storing the element classification information of each element, the circuit element classification relation database having:
a block table, a structure table, a FET table and a NET table, wherein the block table contains a record for each block in the circuit, the structure table contains a record for each structure in the circuit, the FET table contains a record for each FET in the circuit, and the NET table contains a record for each NET in the circuit; and
an association table having an association record for each association between a structure and a block in which the structure is contained, an association record for each association between a FET and a structure in which the FET is contained, and an association record for each association between a NET and a structure in which the NET is contained; and
a relational database storage logic for receiving the element classification information from the circuit recognition engine and storing the information in the circuit element classification relational database.

47. A system for storing circuit element classification information of a digital circuit in a relational database comprising:
a circuit element classification relational database means for storing the element classification information; and
a relational database storage means for receiving the element classification information and storing the information in the circuit element classification relational database means.

48. The system of claim 47, the relational database storage means comprising:
receive element classification means for receiving element classification information regarding each element in a circuit;
create a record in an appropriate element relation means for creating a record in a table of the circuit element classification relational database for containing element classification information regarding an element; and
create at least one association record means for creating at least one association record in an association table of the circuit element classification relational database for each association between elements of the circuit.

49. A method for storing circuit element classification information of a digital circuit in a relational database comprising the steps of:
receiving classification information regarding an element of the circuit;
creating a record in an element table of a circuit element classification relational database to represent the element and its classification information; and
creating at least one association record in an association table of the circuit element classification relational database.

50. The method of claim 49, the creating a record in an element table step further comprising the steps of:
for each element classified as a block, generating a unique block identifier, adding a block record to a block table of the circuit element classification relational database, and including the block identifier and descriptive information regarding the block in the block record;
for each element classified as a structure, generating a unique structure identifier, adding a structure record to a structure table of the circuit element classification relational database, and including the structure identifier and classification information regarding the structure in the structure record;
for each element classified as a FET, generating a unique FET identifier, adding a FET record to a FET table of the circuit element classification relational database, and including the FET identifier and classification information regarding the FET in the FET record; and
for each element classified as a NET, generating a unique NET identifier, adding a NET record to a NET table of the circuit element classification relational database, and including the NET identifier and classification information regarding the NET in the NET record.

51. The method of claim 49, the creating at least one association record step further including the steps of:
for each element classified as a structure, adding an association record to the association table associating the structure to a block in which the structure is contained;
for each element classified as a FET, adding an association record to the association table associating the FET to a structure in which the FET is contained; and
for each element classified as a NET, adding an association record to the association table associating the NET to a structure in which the NET is contained.

52. The method of claim 51, the creating at least one association record step further comprising the step of:
for each element classified as a structure, if the structure has a parent structure, adding an association record to the association table associating the structure to the parent structure.

53. A method for storing circuit element classification information of a digital circuit in a relational database comprising the steps of:
receiving classification information regarding an element of the circuit;
for each element classified as a block, generating a unique block identifier, adding a block record to a block table of a circuit element classification relational database, and including the block identifier and descriptive information regarding the block in the block record;
for each element classified as a structure, generating a unique structure identifier, adding a structure record to a structure table of the circuit element classification relational database, including the structure identifier and classification information regarding the structure in the structure record, and adding an association record to an association table of the circuit element classification relational database associating the structure to a block in which the structure is contained;
for each element classified as a FET, generating a unique FET identifier, adding a FET record to a FET table of the circuit element classification relational database, including the FET identifier and classification information regarding the FET in the FET record, and adding an association record to the association table associating the FET to a structure in which the FET is contained; and
for each element classified as a NET, generating a unique NET identifier, adding a NET record to a NET table of the circuit element classification relational database, including the NET identifier and classification information regarding the NET in the NET record, and adding an association record to the association table associating the NET to a structure in which the NET is contained.
